(19) United States
(12) Patent Application Publication
(10) Pub. No.: US 2024/0026733 A1
(43) Pub. Date: Jan. 25, 2024

(54) DOOR PROTECTOR

(71) Applicant: Tucker R. Hiegel, Ballwin, MO (US)

(72) Inventor: Tucker R. Hiegel, Ballwin, MO (US)

(21) Appl. No.: 18/225,655

(22) Filed: Jul. 24, 2023

Related U.S. Application Data
(60) Provisional application No. 63/391,454, filed on Jul. 22, 2022.

(51) Int. Cl. E06B 7/28

(52) U.S. Cl. CPC E06B 7/28

(57) ABSTRACT

An elongated protector plate including a sheet having an attachment face adapted to face a door surface and an opposite exposed face having an upper edge, a lower edge, an inner edge, and an outer edge. The outer edge is positioned closer to a strike side edge of the door surface than the inner edge when the protector plate is mounted. The sheet has an inner rounded corner where the upper edge meets the inner edge and an outer rounded corner where the upper edge meets the outer edge. The inner rounded corner and the outer rounded corner each have a radius measuring greater than ¼ inch. The sheet has an inner lower corner where the lower edge meets the inner edge and an outer lower corner where the lower edge meets the outer edge. The sheet edges each have an edge treatment blunting the corresponding edge.

### CROSS-REFERENCE TO RELATED APPLICATION

The present application claims priority to U.S. Provisional Patent Application No. 63/391,454 filed on Jul. 22, 2022, and entitled, “DOOR PROTECTOR”, which is hereby incorporated by reference in its entirety.

The present disclosure relates to door protectors, and more particularly to a protective plate for preventing pets from marking or marring a strike side margin of a door.

Kickplates are frequently installed along a lower margin of a door for decoration and to prevent the lower margin of the door from being marked or marred during use. Typically, the kickplate is sized to extend between opposite side edges of a lower margin of a door surface, leaving a small border space between each end of the kickplate and the corresponding side edge of the door surface. Although the border space may have other widths, in most instances a border space of about ⅛ inch to about ½ inch is provided between each side of the kickplate and the corresponding side edge of the door surface. Further, in most instances the kickplate is about 8 inches to about 12 inches tall and is spaced from the lower edge of the door surface by a distance of about ⅛ inch to about 1 inch. In rarer instances, the kickplates may have other heights. Usually the kickplate is attached to the door using screw fasteners but other means such as adhesives may be used to attach the kickplate to the door. The kickplates may be made from a sheet metal (e.g., brass, stainless steel, or aluminum) or sheet plastic (e.g., vinyl). In the case of sheet metal kickplates, the kickplate may be periodically cleaned and polished or replaced after becoming marred during use. When kickplates are made from sheet plastic, they may be washed or replaced after being marred.

In addition to kickplates, some users install a protective guard plate on a surface of a door surrounding a lockset, handle, or doorknob to prevent the corresponding surface of the door from being marked or marred. Further, swinging doors are often fitted with push plates adjacent a side of the door opposite its hinges where a person is likely to engage the door when pushing the door to pivot the door on its hinges. Like kickplates and guard plates, push plates effectively protect the corresponding surface of the door surfaces from marking and marring.

Pet owners, particularly dog owners have found that some pets learn to open doors by pushing the side margin of the door opposite its hinges, i.e., the strike margin. As used herein, the term strike margin shall include a margin of a door surface opposite its hinges regardless of whether the door includes a lock, or the adjacent structures include a strike plate. When a pet encounters a closed door, the pet will often push the strike margin at a level corresponding to their size. Sometimes the pet may open the door on the first try and sometimes it may take several tries. The nature of this intermittent success reinforces this behavior in the pet. Pets often paw at a door when they want to alert a human that they need to or want to go outdoors or come indoors. Repeatedly contacting the door, particularly with a paw having long toenails, tends to mark and mar the door. After many attempts to open the door, the repeated contact can cause substantial damage to the door surface. Thus, there is a need for a door protector to prevent pets from damaging doors. Further, care should be exercised when making elements that pets are likely to contact to prevent those pets from being injured or harmed.

### SUMMARY

In one aspect, the present disclosure includes an elongated protector plate for mounting on a door surface to protect the door surface from being marred by an animal. The door surface extends between a top edge and a bottom edge opposite the top edge and between a hinge side edge and a strike side edge opposite the hinge side edge. The door surface has a strike side margin extending partially across the door surface from the strike side edge toward the hinge side edge. The elongated plate protector comprises an elongated sheet having an attachment face adapted to face the door surface when the protector plate is mounted on the door surface. The sheet has an exposed face opposite the attachment face. The exposed face has an upper edge, a lower edge opposite the upper edge, an inner edge extending between the upper edge and the lower edge, and an outer edge opposite the inner edge. The outer edge is positioned closer to the strike side edge of the door surface than the inner edge when the protector plate is mounted on the door surface with the attachment face facing the door surface and the upper edge positioned closer to the top edge of the door surface than the lower edge. The exposed face has a height extending from the upper edge to the lower edge and a width shorter than the height extending from the inner edge to the outer edge. The sheet has an inner rounded corner where the upper edge meets the inner edge and an outer rounded corner where the upper edge meets the outer edge. The inner rounded corner and the outer rounded corner each have a radius measuring greater than ¼ inch. The sheet has an inner lower corner where the lower edge meets the inner edge and an outer lower corner where the lower edge meets the outer edge. The upper edge, the lower edge, the inner edge, and the outer edge each have an edge treatment blunting the corresponding edge.

In another aspect, the present disclosure includes a door adapted for mounting in a doorway, the door comprising a first face extending between a top edge and a bottom edge opposite the top edge and between a hinge side edge and a strike side edge opposite the hinge side edge, the first face having a strike side margin extending partially across the first face from the strike side edge toward the hinge side edge. a second face opposite the first face; and an elongated protector plate mounted on the strike side margin of the first face of the door, the protector plate having a height extending from an upper edge to a lower edge opposite the upper edge and a width shorter than the height extending from an inner edge and an outer edge opposite the inner edge, the outer edge being closer to the strike side edge of the first face than to the inner side edge; wherein: the upper edge of the elongated protector plate is less than 34 inches above the bottom edge of the of the first face of the door; the outer edge of the elongated protector plate extends parallel to the strike side edge of the first face of the door; the inner edge of the elongated protector plate extends parallel to the outer edge; and the width of the elongated protector plate is less than about six inches.

In yet another aspect, the present disclosure includes a method of protecting a door having a door surface extending between a top edge and a bottom edge opposite the top edge and between a hinge side edge and a strike side edge opposite the hinge side edge, the door surface having a strike side margin extending partially across the first face from the strike side edge toward the hinge side edge, the method comprising the steps of obtaining an elongated protector plate having a height extending from an upper edge to a lower edge opposite the upper edge and a width shorter than the height extending from an inner edge and an outer edge opposite the inner edge orienting the protector plate so the upper edge is positioned above the lower edge and the attachment surface faces the door surface positioning the oriented protector plate so the outer edge is less than about one inch from the strike side edge and the upper edge of the protector plate is less than 34 inches above the bottom edge of the door; and attaching the positioned protector plate to the door.

Other aspects of the present disclosure will be apparent in view of the following description and claims.

### BRIEF DESCRIPTION OF DRAWINGS

The present disclosure includes non-limiting examples illustrated in the accompanying drawings.

FIG. 1 is a front elevation of a door having a protector suitable for contact by a pet;

FIG. 2 is a cross section of the door and protector of FIG. 1 taken in the plane of line 2-2 of FIG. 1; and

FIG. 3 is a detail of the door and protector in an area identified in FIG. 2.

Corresponding reference characters indicate corresponding parts throughout the drawings.

### DETAILED DESCRIPTION

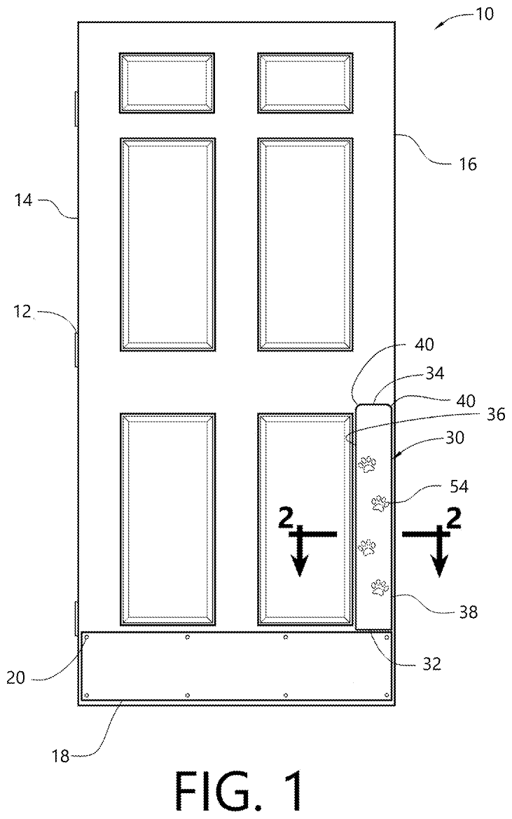

As illustrated in FIGS. 1-3, an example of a door is generally designated in its entirety by the reference number 10. The illustrated door 10 is a traditional six-panel, solid wood door but may be a door of any conventional type, including a luan-faced panel door, a hollow vinyl door, or an exterior metal door. As shown in FIG. 1, the door is mounted on hinges 12, allowing the door to pivot when opening and closing. The hinges 12 are positioned on a hinge side 14 of the door 10. The door 10 has a strike side 16 opposite the hinge side 14. As used herein, the phrase strike side shall include a side of a door surface opposite its hinges regardless of whether the door includes a lock, or the adjacent structures include a strike plate. The illustrated door 10 also includes a conventional kickplate 18 attached adjacent a lower margin of the door with screw fasteners 20. As used herein, the term margin shall include a surface area adjacent to a corresponding edge that extends partially across the door surface from the corresponding edge toward an opposite edge. In some examples, it is envisioned that the door may not have a kickplate and/or the door may have other conventional protective plates such as guard plates surrounding handles or push plates. Other aspects of the door 10 and conventional protective plates (e.g., kickplate 18) are well known to those skilled in the art and will not be described in further detail.

The illustrated door 10 also includes a protector plate or pet protection plate, generally designated by the reference number 30. The protector plate 30 is mounted adjacent the strike side 16 of the door surface immediately above the kickplate 18 as shown in FIG. 1. The protector plate 30 has a height extending lengthwise between a lower edge 32 and an upper edge 34. In instances where the kickplate 18 is not present, the lower edge 32 may be positioned adjacent a lower edge of the door 10. It is envisioned that longer plates 30 can be manufactured for this alternative installation. The protector plate 30 has a width extending between an inner edge 36 and an outer edge 38 that is shorter than its height. As used herein, the phrase inner edge shall include a side edge that is closer to the hinge side of the door 30 than the opposite side edge, and the phrase outer edge shall include a side edge opposite the inner edge. Although the protector plate 30 may have other widths, in most examples the protector plate width is less than about seven inches. Thus, it is envisioned that most protector plates have widths that are less than the height of most conventional kickplates.

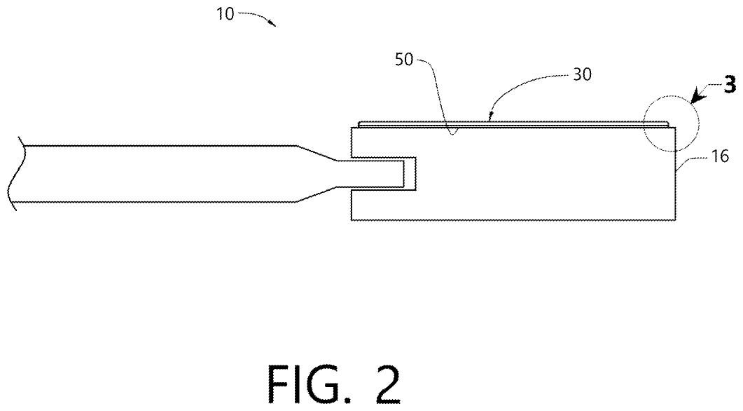

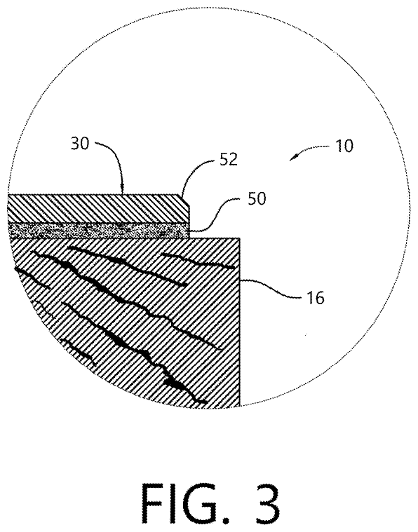

The pet protection plate 30 includes several features to prevent the pet from being harmed or injured when contacting the plate. As shown in FIG. 1, the upper edge 34 of the illustrated protector plate 30 has rounded corners 40 where the upper edge meets the inner edge 36 and the outer edge 38. The rounded corners 40 eliminate a sharp corner that could cut or otherwise injure a pet when the pet contacts the protective plate 30. Further, in the example illustrated in FIGS. 2 and 3, the plate 30 is attached to the door 10 using an adhesive 50. In one example, the adhesive 50 comprises VHB™ adhesive tape or sheet available from 3M Company of Saint Paul, Minnesota. Using adhesive 50 rather than screw fasteners eliminates potential burrs that sometimes develop on screw fastener heads that could also scratch or otherwise injure a pet. In an alternative (not shown), the plate 30 may have a magnetized layer for attaching the plate to ferromagnetic material such as a steel door. As further shown in FIG. 3, all exposed, outward-facing edges surrounding the illustrated plate 30 have an edge treatment (e.g., a beveled edge 52, a break edge, or a rounded edge) to eliminate sharp edges that could cut or otherwise injure a pet. Although the beveled edge 52 may be made in other ways, in one example the bevel will be machine milled and hand tooled to eliminate residual burrs.

In some examples, the plate 30 comprises anodized aluminum, allowing the plate to be offered in a variety of colors (e.g., black, nickel, brass, or oil rubbed bronze). It is envisioned that the plate 30 may be mass produced in lengths and widths chosen to correspond with commonly available door configurations. The plate 30 also may be offered in custom lengths and widths. Further customizations such as engraved symbols (e.g., footprints 54), logos, and phrases are also envisioned.

To install the protector plate 30, the installer attaches the plate adjacent to a strike edge 16 of a door 10 so the outer edge 38 of the protector plate extends parallel to the strike edge. Thus, the installer orients the protector plate so its upper edge is positioned above the lower edge and its attachment surface faces the door surface. The installer positions the oriented protector plate so the outer edge is less than about one inch from the strike edge of the door and the upper edge of the protector plate is at a desired height on the door surface. In most examples, the protector plate 30 is mounted on the door surface so its upper edge is below conventional doorhandle level (i.e., less than about 34 inches from the bottom edge of the door). In cases where the door includes a guard plate or push plate, it is envisioned that the protector plate is mounted on the door such that its upper edge is below the guard plate or push plate. Further, in cases where the door has a kickplate, it is envisioned that the protector plate is mounted on the door surface such that its lower edge is above the kickplate. In cases where the door does not have a kickplate, the lower edge may extend downward to a position adjacent to the bottom edge of the door surface. In some instances, it is envisioned that the protector plate may be formed as one piece with the guard plate or push plate. As will be appreciated, the protector plate 30 may be installed on either surface of an interior or an exterior door.

When introducing elements in this description and the claims, the articles “a”, “an”, “the”, and “said” are intended to indicate one or more of the elements. The terms “comprising”, “including”, and “having” are intended to be inclusive and indicate there may be additional elements other than the listed elements.

As those skilled in the art could make various changes to the above constructions, products, and methods without departing from the intended scope of the description, all matter in the above description and accompanying drawings should be interpreted as illustrative and not in a limiting sense. The patentable scope of the disclosure is defined by the claims, and can include other constructions and methods that would occur to those skilled in the art. Such other constructions are intended to be within the scope of the claims if the structural elements of the constructions do not differ from the literal language of the claims, or if the constructions include equivalent structural elements having insubstantial differences from the literal languages of the claims.

To the extent that the specification, including the claims and accompanying drawings, discloses any additional subject matter that is not within the scope of the claims below, the disclosures are not dedicated to the public and the right to file one or more applications to claims such additional disclosures is reserved.

1. An elongated protector plate for mounting on a door surface to protect the door surface from being marred by an animal, said door surface extending between a top edge and a bottom edge opposite said top edge and between a hinge side edge and a strike side edge opposite said hinge side edge, said door surface having a strike side margin extending partially across the door surface from the strike side edge toward the hinge side edge, said elongated plate protector comprising:
an elongated sheet having an attachment face adapted to face the door surface when the protector plate is mounted on the door surface, said sheet having an exposed face opposite said attachment face, said exposed face having an upper edge, a lower edge opposite the upper edge, an inner edge extending between the upper edge and the lower edge, and an outer edge opposite said inner edge, said outer edge being positioned closer to the strike side edge of the door surface than the inner edge when the protector plate is mounted on the door surface with the attachment face facing the door surface and the upper edge positioned closer to the top edge of the door surface than the lower edge, said exposed face having a height extending from the upper edge to the lower edge and a width shorter than said height extending from the inner edge to the outer edge, said sheet having an inner rounded corner where the upper edge meets the inner edge and an outer rounded corner where the upper edge meets the outer edge, said inner rounded corner and said outer rounded corner each having a radius measuring greater than ¼ inch, said sheet having an inner lower corner where the lower edge meets the inner edge and an outer lower corner where the lower edge meets the outer edge, and the upper edge, the lower edge, the inner edge, and the outer edge each have an edge treatment blunting the corresponding edge.

2. An elongated protector plate as set forth in claim 1, wherein the edge treatment is selected from a group of treatments consisting of a beveled edge, a break edge, and a rounded edge.

3. An elongated protector plate as set forth in claim 2, wherein the edge treatment is a beveled edge.

4. An elongated protector plate as set forth in claim 1, wherein the width is less than about seven inches.

5. An elongated protector plate as set forth in claim 1, further comprising an adhesive applied to the attachment face of the sheet.

6. An elongated protector plate as set forth in claim 1, wherein the sheet comprises aluminum.

7. An elongated protector plate as set forth in claim 6, wherein the aluminum has an anodized surface.

8. An elongated protector plate as set forth in claim 1, wherein the exposed face includes indicia thereon.

9. An elongated protector plate as set forth in claim 1, in combination with the door.

10. A door adapted for mounting in a doorway, said door comprising:
a first face extending between a top edge and a bottom edge opposite said top edge and between a hinge side edge and a strike side edge opposite said hinge side edge, said first face having a strike side margin extending partially across the first face from the strike side edge toward the hinge side edge;
a second face opposite said first face; and
an elongated protector plate mounted on the strike side margin of the first face of the door, said protector plate having a height extending from an upper edge to a lower edge opposite said upper edge and a width shorter than said height extending from an inner edge and an outer edge opposite said inner edge, said outer edge being closer to the strike side edge of the first face than to the inner side edge;
wherein:
the upper edge of the elongated protector plate is less than 34 inches above the bottom edge of the of the first face of the door;
the outer edge of the elongated protector plate extends parallel to the strike side edge of the first face of the door;
the inner edge of the elongated protector plate extends parallel to the outer edge; and
the width of the elongated protector plate is less than about six inches.

11. A method of protecting a door having a door surface extending between a top edge and a bottom edge opposite said top edge and between a hinge side edge and a strike side edge opposite said hinge side edge, said door surface having a strike side margin extending partially across the first face from the strike side edge toward the hinge side edge, said method comprising the steps of:
obtaining an elongated protector plate having a height extending from an upper edge to a lower edge opposite said upper edge and a width shorter than said height extending from an inner edge and an outer edge opposite said inner edge;
orienting the protector plate so the upper edge is positioned above the lower edge and the attachment surface faces the door surface;
positioning the oriented protector plate so the outer edge is less than about one inch from the strike side edge and the upper edge of the protector plate is less than 34 inches above the bottom edge of the door; and
attaching the positioned protector plate to the door.

12. A method as set forth in claim 11 wherein:
the door has at least one of a push plate, a handle, and a knob; and
the step of positioning the protector plate includes the step of positioning the upper edge below said at least one of the push plate, the handle, and the knob.

13. A method as set forth in claim 11 wherein:
the door has a kickplate positioned adjacent to the bottom edge of the door and extending across the door surface between the hinge side edge and the strike side edge; and
the step of positioning the protector plate includes the step of positioning the lower edge above the kickplate.

14. A method as set forth in claim 11 wherein:
the door has at least one of a push plate, a handle, and a knob;
the door has a kickplate positioned adjacent to the bottom edge of the door and extending across the door surface between the hinge side edge and the strike side edge; and
the step of positioning the protector plate includes the steps of:
positioning the upper edge below said at least one of the push plate, the handle; and
the knob positioning the lower edge above the kickplate.
